(19) United States
(12) Patent Application Publication
(10) Pub. No.: US 2004/0112472 A1
(43) Pub. Date: Jun. 17, 2004

(54) Metal particle data recording medium having enhanced elastic modulus

(75) Inventors: Cheri X. Pereira, Fremont, CA (US); Andrei Potanin, Woodbury, MN (US)

Correspondence Address: Attention: Eric D. Levinson, Imation Corp., Legal Affairs, P.O. Box 64898, St. Paul, MN, 55164-0898, US

(73) Assignee: Imation Corp.

(21) Appl. No.: 10/321,898

(22) Filed: Dec. 17, 2002

(51) Int. Cl. H01F 1/04

(52) U.S. Cl. 148/300; 428/692; 428/402

(57) ABSTRACT

A surface treated magnetic pigment particle suitable for use with a binder in an information-recording layer of magnetic recording media. The surface treated magnetic pigment particle is a magnetic pigment particle with at least first and second surface treatment agents adsorbed onto the surface of the magnetic pigment particle. The first surface treatment agent has the formula E—X¹—A¹ wherein E is an electron withdrawing group which is not reactive with the binder, A¹ is an acidic group, and X¹ is a divalent moiety. The second surface treatment agent has the formula F—X²—A² wherein F is a functional group reactive with the binder, A² is an acidic group, and X² is a divalent C₁₋₄ alkyl moiety.

### FIELD OF TE INVENTION

The invention relates to metal particle data recording media.

### BACKGROUND

Magnetic recording media generally comprise at least one magnetizable layer (also commonly referred to as an “information storing layer” or ““magnetic recording layer”) coated onto at least one side of a substrate. For particulate magnetic recording media, the magnetizable layer comprises a magnetic pigment dispersed in a polymeric binder. The polymeric binder of a magnetic recording medium is most commonly prepared from a polymer blend comprising a hard component (i.e., a polymer with relatively high glass transition temperature and modulus), and a soft component (i.e., a polymer with relatively low glass transition temperature and modulus). In addition to the binder and magnetic pigment, the magnetic layer may also include other components such as lubricants, abrasives, thermal stabilizers, catalysts, crosslinkers, antioxidants, dispersants, wetting agents, fungicides, bactericides, surfactants, antistatic agents, nonmagnetic pigments, coating aids, and the like.

Some forms of magnetic recording media, such as magnetic recording tape may also have a backside coating applied to the other side of the substrate in order to improve the durability, conductivity, and tracking characteristics of the media. The backside coating also includes a polymeric binder and other components such as lubricants, abrasives, thermal stabilizers, catalysts, crosslinkers, antioxidants, dispersants, wetting agents, fungicides, bactericides, surfactants, antistatic agents, nonmagnetic pigments, coating aids, and the like.

The polymeric binders of the magnetic layer and the backside coating are commonly derived from polymers which require curing in order to provide magnetic recording media with appropriate physical and electromagnetic properties. To prepare such media, the components of the magnetic layer or the backside coating, as appropriate, are combined with a suitable solvent and thoroughly mixed to form a homogeneous dispersion. The resulting dispersion is then coated onto the nonmagnetizable substrate, after which the wet coating is passed through a magnetic field in order to orient, or randomize in some cases, the magnetic pigment. The oriented coating is then dried, calendered if desired, and then cured.

Magnetic pigment particles are often treated with a surface treatment agent for purposes of (i) improving dispersion of the magnetic pigment particles within the binder, and thereby improving the electromagnetic performance of the media, and/or (ii) increasing the strength of adhesion between the magnetic pigment particles and the binder, and thereby enhancing the strength and durability of the information storing layer. Indeed, a wide variety of surface treatment agents and methods are known. However, the various surface treatment agents tend to improve certain mechanical and/or electromagnetic properties (e.g., dispensability of pigment) at the expense of others (e.g., durability). Hence, the search continues for surface treatment agents and methods capable of achieving improved mechanical and/or electromagnetic properties without or with a minimal loss of other desired mechanical and/or electromagnetic properties.

### SUMMARY OF THE INVENTION

A first aspect of the invention is a surface treated magnetic pigment particle suitable for use with a binder in an information-recording layer of magnetic recording media. The surface treated magnetic pigment particle is a magnetic pigment particle with at least first and second surface treatment agents adsorbed onto the surface of the magnetic pigment particle. The first surface treatment agent has the formula E—X¹—A¹ wherein E is an electron withdrawing group which is not reactive with the binder, A¹ is an acidic group, and X¹ is a divalent moiety. The second surface treatment agent has the formula F—X²—A² wherein F is a functional group reactive with the binder, A² is an acidic group, and X² is a divalent C₁₋₄ alkyl moiety.

A second aspect of the invention is a magnetic recording medium which includes a substrate and an information storing layer on the substrate. The information storing layer on the substrate includes at least a binder and a plurality of magnetic pigment particles with at least first and second surface treatment agents adsorbed onto the surface of the magnetic pigment particles. The first surface treatment agent is not reactive with the binder, while the second surface treatment agent is reactive with the binder.

### DETAILED DESCRIPTION OF THE INVENTION INCLUDING A BEST MODE

### Definitions

As utilized herein, including the claims, the term “bond” includes ionic and covalent bonds.

As utilized herein, including the claims, the term “reactive” means capable of forming a stable bond.

### Construction of Particulate Magnetic Recording Media

Magnetic recording media generally comprise at least one magnetizable layer (also commonly referred to as an “information storing layer” or “magnetic recording layer”) coated onto at least one side of a substrate. For particulate magnetic recording media, the magnetizable layer comprises magnetic particles dispersed in a polymeric binder.

The embodiments of the present invention described below are not intended to be exhaustive or to limit the invention to the precise forms disclosed in the following detailed description. Rather the embodiments are chosen and described so that others skilled in the art may appreciate and understand the principles and practices of the present invention.

Magnetic recording media of the present invention comprise at least one information-storing layer provided on one or both surfaces of a substrate. In constructions such as magnetic tape or diskettes in which the substrate is substantially planar and has first and second opposed major surfaces, one or both surfaces of the substrate may be coated with an information storing layer. If only one side of the substrate bears an information storing layer, and if the embodiment is a tape, then the other side is preferably coated with a so-called backside coating that typically comprises a dispersion of nonmagnetic pigment(s) in a polymeric binder. Such backside coatings are typically used in order to impart desirable friction, antistatic, smoothness, and other properties to the magnetic recording medium in accordance with well known practices.

In an alternative so-called ““Multiple Layer” construction, two or more layers may be coated onto the same side of the substrate, wherein at least one of the layers is an information storing layer comprising surface treated magnetic pigment of the present invention. If more than one of such layers comprises magnetic pigment, then the magnetic pigment in all the layers need not be the same. For example, the magnetic pigment used in one layer may have a different coercivity than the magnetic pigment used in another layer. Likewise, the magnetic pigment of one layer may be surface treated in accordance with the present invention, whereas the magnetic pigment of another layer may bear another surface treatment or may not be surface treated at all. If only one of such layers includes a magnetic pigment, then the other layer(s) may comprise a dispersion of nonmagnetic pigment particles in a polymeric binder.

Substrate

The particular nonmagnetizable substrate of the present invention may be formed from any suitable substrate material known in the art. The substrate can be rigid or flexible, depending upon the intended end use of the magnetic recording medium. Examples of suitable substrate materials include, for example, polymers such as polyethylene terephthalate (“PET”), polyimide, and polyethylene naphthalene (“PEN”); metals such as aluminum or copper; paper; and any other suitable material. Suitable substrates can have a variety of thicknesses, but most typically have a thickness in the range of from about 8 to 120 gauge for tape and from 1 to 4 mils for disks.

Magnetic Particles

The type of magnetic pigment used in the present invention may include any suitable magnetic pigment known in the art including γFe₂O₃, cobalt-doped γFe₂O₃, γFe₃O₄, CrO₂, barium ferrite, barium ferrite derivatives, and ferromagnetic metal particles. The present invention is particularly advantageously used with ferromagnetic metal particle pigments. Generally, pigment particles preferred for use in the magnetizable layer of particulate magnetic recording media are acicular or needle like magnetic particles. The average particle length of these particles along the major axis is preferably less than about 0.2 μm, and more preferably, less than about 0.1 μm. The particles preferably exhibit an axial ratio (i.e., a length to diameter ratio) of from about 3 to 1 up to about 8 to 1. Preferred particles have a specific surface area of at least about 40 m²/g, more preferably of at least about 50 m²/g. Such particles typically include a metal content of at least 70 wt %, preferably at least 75 wt % of metal in the form of ferromagnetic metals or metal alloys such as Fe, Fe—Co, Co, Ni, Co—Ni, Fe—Mn—Zn, Fe—Co—Ni—Cr, Fe—Co—Ni—P, Fe—Co—B, Fe—Co—Cr—B, Fe—Co—V, Co-phosphorous, and the like. A wide variety of ferromagnetic metal particle pigments are available commercially. Specific examples include D3-19, D3-41, HM-77, HM-101, and HM-94 pigments from Dowa Mining Co., Ltd., Tokyo, Japan; BR-1, DR-1, and F-1 pigments from Toda Kogyo Corp., Hiroshima, Japan; and MAPEX E3-1300HB, E3-1650HB, EI-2, and EI-3 pigments from Kanto Denka Kogyo Co., Ltd., Tokyo, Japan.

A preferred particle is a magnetic alloy particle having high coercivities and high saturation magnetization that preferably include about 15 to 45 atomic %, preferably 20 to 45 atomic %, Co based on the amount of Fe present (i.e., 100×(atoms of Co/atoms of Fe)). Preferably, these alloy particles have coercivities greater than about 1800 Oersteds (Oe), more preferably from about 1500 to about 2800 Oe, and even more preferably, about 2000 to about 2800 Oe. The saturation of magnetization of the alloy particles is preferably greater than or equal to 100 emu/g and, more preferably, greater than 120 emu/g. Such metal alloy particles can be prepared by the method described in U.S. Pat. No. 5,735,969 (Lown et al.), and are commercially available from a number of sources such as Dowa Mining, Kanto Denka, and Toda Kogyo Corporation.

The pigments which are most beneficially treated with compounds of this invention have a basic surface. Without wishing to be bound by theory, it is reasonable to assume that the acidic sites on the surface modification agent bind to the basic sites on the pigment surface. For example, the surfaces of the metal particle magnetic particles are generally coated with anti-sintering agents during their manufacture. Common anti-sintering agents applied to pigment surfaces are oxides or hydroxides of aluminum, silicon, boron, calcium, magnesium, yttrium, neodynium, lanthanum, samarium, cerium, praseodynium, gadolinium, mixtures of these and the like. The anti-sintering agents are applied to the pigment to provide the final ferromagnetic metal powder with good oxidation resistance and also to preserve the shape of the particles during their manufacture. These anti-sintering agents and combinations thereof are typically applied at levels which result in the final ferromagnetic metal powder having a basic surface (i.e., these anti-sintering agents provide basic sites on the surfaces of the particles for binding the surface modification agent of the present invention and for binding the self-wetting polymer. If the pigment surface is very basic, it is difficult to disperse the particles without neutralizing the surface. One aspect of the present invention is that the acidic surface modifiers react strongly with basic sites on the pigment to neutralize the pigment surface and provide for more effective dispersion.

The high magnetic moment of ferromagnetic metal particle pigments combined with their high coercivity and small size makes them especially difficult to disperse. Even if one disperses them effectively, they can agglomerate during orientation, causing dispersion migration and orientation roughness. The present invention is particularly useful in stabilizing dispersions of ferromagnetic metal particles with magnetic moments of over 100 emu/g and having coercivities of over 1500 Oe.

Surface Treatment Agents

First and second surface treatment agents are adsorbed onto the surfaces of the magnetic pigment, rendering the magnetic recording media manufactured from such treated particles easier to manufacture with improved mechanical and electromagnetic performance properties.

The first surface treatment agent is a compound comprising at least one acidic group and at least one electron withdrawing group which is not reactive with a given binder. Advantageously, the use of a surface treatment agent with this kind can improve dispensability of the magnetic pigment particles in the binder. The second surface treatment agent is a compound comprising at least one acidic group and at least one functional group reactive with the given binder. Advantageously, the use of a surface treatment agent with this kind can improve durability of the magnetic recording media.

While not wishing to be bound by theory, it is believed that the acidic group of the surface treatment agents is attracted to and binds with, or otherwise engages, a compatible site on the surface of a corresponding magnetic pigment particle. When a particle surface is treated with such agents, therefore, the agents form a spacing layer around the particle. In such a spacing layer, the acidic group of the surface treatment agent tends to be proximal to the surface of the treated particle, and the other group (i.e., the electron withdrawing group of the first surface treatment agent or the reactive functional group of the second surface treatment agent) tends to be more towards the outer surface of the spacing layer. In practical effect, a surface treated particle is surrounded by a “shell” containing both electron withdrawing groups and reactive functional groups. The negative charge density generated by the electron withdrawing groups helps increase the steric stabilization of the pigment and polymer, strongly interacts with any positively charged groups of the binder to promote better dispersion, and helps prevent agglomeration of the pigment particles themselves. The reactive functional groups bond to reactive functional groups on the binder so as to provide a strong adhesion of the pigment particles to the binder and thereby enhance durability.

During the process of manufacturing the information storing layer, the acidic groups of the surface treatment agents tend to compete with other acidic components of the information storing layer for the basic binding sites on the magnetic pigment. The ability of the surface treatment agents to compete more effectively depends, in part, upon the degree of acidity of the surface treatment agents acidic group relative to other functional groups present on the information storing layer. Generally, because stronger acidic groups compete more effectively for binding sites than weaker acidic groups, the acidic group of the first surface treatment agent is preferably at least as acidic, and most preferably more acidic, than any other functional groups present in the other information storing layer components, particularly the dispersing groups of the polymeric binder, to the extent that any are acidic.

The degree of acidity of a particular functional group corresponds to the pKa value associated with that group. As used herein, the term pKa′ refers to the negative logarithm of the acid dissociation constant, Ka. For an organic acid or alcohol of the formula ROH, Ka is defined as

Ka=[H₃O⁺][RO⁻]/[ROH]

where the concentrations of the reactants are defined in units of molarity or moles/liter. pKA is described in, for example, Introduction to Organic Chemistry, Andrew Streitwieser, Jr. and Clayton H. Heathcock, McMillan Publishing Co., Inc. (New York, N.Y. 1976), pp. 214-216. Generally, a compound with a lower pKa value is more acidic than a compound with a higher pKa value.

Generally, the acidic group of the surface treatment agents should have a pKa of no greater than about 4.0 in order to be effective in combination with the binder. For certain applications, dependant in large part upon the type of binder employed, the acidic group can still be effective at pKa values of up to about 4.5.

A wide variety of acidic groups may be used as the acidic group on the surface treatment agents with beneficial results. Representative examples of suitable acidic groups include an anhydric group, a —COOH group, sulfonic acid, a phosphonic acid group, salts of such groups, combinations of such groups, and the like. Of these, —COOH is presently most preferred in combination with metal particle magnetic pigments. In the practice of the present invention, a salt of an acidic group is also deemed to be an acidic group within the scope of the invention.

The information storing layer desirably incorporates a sufficient amount of the surface treatment agents effective to ease dispersion and help prevent agglomeration of the magnetic pigment during preparation of the magnetic recording medium, and improve durability of the magnetic recording medium. The optimum amount of surface treatment agents will depend upon a number of factors including the acid equivalent weight of the surface treatment agents, the specific surface area of the magnetic pigment being surface treated, the pH of the magnetic pigment being treated, and the like. As one example, when using one of the metal powder magnetic pigments such as those commercially available under the trade designation Dowa HM-77 or Toda BR-I or the like, using 0.0005 to 0.05, more preferably 0.005 to 0.030 moles of acid functional groups per 100 grams of the pigment has been found to be suitable.

First Surface Treatment Agent

The first surface treatment agent is a compound comprising at least one acidic group and at least one electron withdrawing group which is not reactive with a given binder. The first surface treatment agent promotes better dispersion, and helps prevent agglomeration of the pigment particles themselves.

The advantages of employing a first surface treatment agent can be increased as the spacing between the electron withdrawing group and the acidic group on the first surface treatment agent is increased. Accordingly, it is preferred that the acidic group and electron withdrawing group on the first surface treatment agent are spaced a significant distance apart from one another by an intermediate backbone. More preferably, it is particularly preferred that the first surface treatment agent includes an electron withdrawing group and an acidic group pendant from substantially opposite ends of an organic backbone, most preferably an aromatic backbone.

The electron withdrawing group is generally a moiety with a high electron affinity or high ionization potential. Electronegativity was originally defined by Pauling as “the power of an atom in a molecule to attract electrons to itself.” [Linus Pauling, The Nature of the Chemical Bond 3rd Ed. Cornell University Press, Ithaca, N.Y. 1960, p.88.] The electronegativity or electron-withdrawing capacity of a group depends upon the electronic charge and hybridization of the atoms in the functional group, and hence depends on the composition of the molecule in which it is incorporated. Preferably, what is meant by the term electron-withdrawing group in this specification is a group which, if substituted for a hydrogen atom (other than the acidic H) on a carboxylic acid, would cause the acid to possess a lower pKa (i.e., the functional group has a Hammett Substituent Constant greater than 0.1 as described in Introduction to Organic Chemistry, Andrew Streitwieser, Jr. and Clayton H. Heathcock, McMillan Publishing Co., Inc. (New York, N.Y. 1976), pp. 947-949). Representative examples of electron withdrawing groups include nitro, chloro, bromo, fluoro, iodo, oxo, perfluoroalkyl (such as trifluoromethyl), perfluoroalkoxy, hydroxy, cyano, combinations of these, and the like.

In one preferred embodiment, the first surface treatment agent is a compound having the formula

E—X—A

wherein E is the electron withdrawing group, A is the acidic group, and X comprises a divalent moiety. Preferably X is an aromatic ring, and E and A are substituents of the aromatic ring at meta or para positions relative to each other. More preferably, E and A are at a para position relative to each other. Due to greater spacing between the E and A groups, the surface treatment agent is much more effective when E and A are at a meta or para position relative to each other as compared to the performance of the agent if E and A were to be ortho to each other.

One representative class of compounds having the general formula E—X—A, where X is an aromatic ring, may be represented by the formula

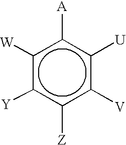

wherein of the ring substituents A, U, V, W, Y, and Z, A is the acidic group; at least one of Y, Z, and V is an electron withdrawing group E as defined above; and each of the other ring substituents not an A or E group is not reactive with a given binder and is independently a monovalent group or, in combination with another substituent not an A or E group, a co-member of a ring structure fused to the ring shown in the formula. Representative examples of monovalent moieties suitable for use as a ring substituent which are not reactive with a given binder include an additional A group, an additional E group; as well as hydrogen, alkyl, aryl, aralkyl, aryloxy, alkoxy, piperidino, morpholino, carboxy, carboxyamido, alkenyl, cycloalkyl, piperazino, carboxyalkyl, and combinations thereof. Any of such moieties, if cyclic, can include a plurality of rings if desired.

Another representative class of compounds having the general formula E—X—A may be represented by the formula

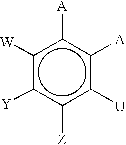

wherein of the ring substituents A, U, W, Y, and Z, each A is independently an acidic group as defined above; at least one of Y and Z is an electron withdrawing group E as defined above; and each of the other ring substituents not an A or E group is not reactive with a given binder and is independently a monovalent group or, in combination with another substituent not an A or E group, a co-member of a ring structure fused to the ring shown in the formula, as defined above. In some embodiments of the invention, the two A groups of this formula are co-members of an acidic anhydric group such that the compound has the formula

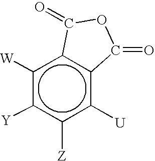

Another representative class of compounds having the general formula E—X—A may be represented by the formula

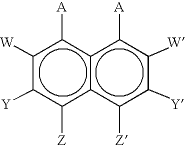

wherein of the ring substituents A, W, W′, Y, Y′, Z, and Z′, each A is independently an acidic group as defined above; at least one of Y, Y′, Z, or Z′ is an electron withdrawing group E as defined above; and each of the other ring substituents not an A or E group is not reactive with a given binder and is independently a monovalent group or, in combination with another substituent not an A or E group, a co-member of a ring structure fused to the ring shown in the formula, as defined above. In some embodiments of the invention, the two A groups of this formula are co-members of an acidic anhydric group such that the compound has the formula

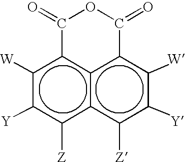

In the practice of the present invention, the moiety X may also comprise a heterocyclic aromatic moiety comprising an aromatic ring incorporating a heteroatom such as N, S, or the like. Thus, compounds such as picilinic acid or nicotinic acid which include at least one E group as a substituent may also be used as the first treatment agent.

In another embodiment of the invention, the first surface treatment agent is a compound of the aromatic formula

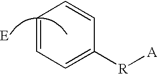

wherein E is an electron-withdrawing group as defined above and is preferably meta or para to the —R—A substituent; A is an acidic group as defined above; and R is a divalent linking group, preferably a divalent linking group of 1 to 4 carbon atoms such as —CH₂—, —CH₂CH₂—, —CH═CH—, —C≡C—, and the like. The other substituents of the aromatic ring not E or —R—A may be any monovalent ring substituent which is not reactive with a given binder as defined above.

Representative examples of compounds having the general formula E—X—A include 4-bromophenylacetic acid; 4-nitro-3-hydroxy benzoic acid; 4-nitrobenzoic acid; 4-nitrophenylacetic acid; 4-chlorobenzoic acid; 3,4-dichlorobenzoic acid; 2,5-dinitrobenzoic acid; 3,4-dinitrobenzoic acid; 3,5-dinitrobenzoic acid; 4-nitrobenzylphosphonic acid; 3-hydroxy benzoic acid; 3-hydroxy phenylacetic acid; 4-chlorobenzoic acid; 3,4-dichlorobenzoic acid; 4-hydroxy-3-nitrophenyl acetic acid; 3,5-dihydroxy benzoic acid; 4-trifluoromethylbenzylphosphonic acid; 4-methlysulfonylbenzylphosphonic acid; 4-nitro picolinic acid; 4-nitro nicotinic acid; 5-hydroxy nicotinic acid; 4-nitro cinnamic acid; 5-nitro-2-furoic acid; 5-(4-nitrophenyl)-2-furoic acid; 5-nitro-3-pyrazole carboxylic acid; 3-nitrophthalic anhydride; salts of these acids; combinations of these acids; and the like.

Another representative class of compounds having the formula E—X—A which may be usefully employed as the first surface treatment agent are compounds wherein X is a divalent moiety comprising a nonaromatic backbone. Preferably, E and A are each pendent from substantially opposite ends of said backbone. Representative examples of compounds according to this formula include bromoacetic acid, glycolic acid, nitromethane trispropionic acid, 3,8-dibromo octanoic acid, 5-nitro-2-oxo-valeric acid, salts of these acids, combinations of these acids, and the like.

Second Surface TreatmentA ent

The second surface treatment agent is a compound comprising at least one acidic group and at least one functional group reactive with the given binder. The first surface treatment agent promotes improved durability of the magnetic recording media.

The reactive functional group is capable of reacting with the given binder so as to crosslink the second surface treatment agent onto the given binder. Exemplary reactive functional groups include groups such as —OH groups, —NH₂ groups, SH groups, and vinyl groups.

Examples of molecules that would be useful as a second surface treatment agent and crosslinkable with preferred polymeric binders may be represented by the formula

F—X—A

wherein A is the acidic group or salt thereof as defined above; F is a reactive functional group capable of crosslinking with a given binder (e.g., —OH, —NH₂, —SH, or a vinyl group); and X is any suitable divalent linking group, such as is defined above. The linking group X can be aromatic or non-aromatic. F can be connected directly to a carbon atom on the linking group X, or can be connected to the linking group X through an intermediary group as an alkylene, alkoxy or alkoxy chain (e.g., —CH₂O—, —CH₂CH₂O— or —(CH₂O)ₙ—). Preferably, when X is an aromatic group, the F and A groups are bonded to the aromatic group in meta- or para-positions to each other, and when X is a non-aromatic group, the F and A are each pendent from substantially opposite ends of said non-aromatic group.

Specific examples of compounds according to the formula F—X—A include

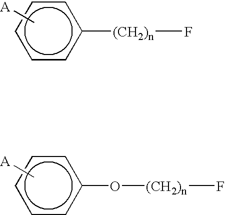

wherein n is typically 0 to 10, preferably 1 to 7, and the acidic group A is desirably meta or para to the substituent containing the F group.

Other examples include compounds in which a crosslinkable double bond is part of a ring structure, such as

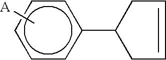

and

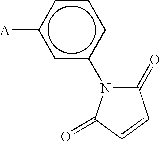

Further examples of compounds according to the formula F—X—A include compounds in which X is a C₁₋₄ divalent alkyl group (i.e., methyl, ethyl, n-butyl, t-butyl, n-propyl, 2-propyl, and 3-propyl). Representative examples of such compounds include specifically, but not exclusively, hydroxymethyl phosphonic acid, hydroxyethyl phosphonic acid, hydroxymethyl sulphonic acid, and hydroxyethyl sulphonic acid. Use of such short chain compounds has been found to facilitate desired movement of the pigment particles during film orientation.

Binders

Suitable binders that can be used in the magnetic layer include, for example, vinyl chloride vinyl acetate copolymers, vinyl chloride vinyl acetate vinyl alcohol ter-polymers, vinyl chloride vinyl acetate maleic acid ter-polymers, vinyl chloride vinylidene chloride copolymers, vinyl chloride acrylonitrile copolymers, acrylic ester acrylonitrile copolymers, acrylic ester vinylidene chloride copolymers, methacrylic ester vinylidene chloride copolymers, methacrylic esterstyrene copolymers, thermoplastic polyurethane resins, phenoxy resins, polyvinyl fluoride, vinylidene chloride acrylonitrile copolymers, butadiene acrylonitrile copolymers, acrylonitrile butadiene acrylic acid copolymers, acrylonitrile butadiene methacrylic acid copolymers, polyvinyl butyral, polyvinyl acetal, cellulose derivatives, styrene butadiene copolymers, polyester resins, phenolic resins, epoxy resins, thermosetting polyurethane resins, urea resins, melamine resins, alkyl resins, urea formaldehyde resins, and the like.

The binders may be provided in a suitable non-aqueous solvent, such as methylene chloride, acetone, methyl ethyl ketone, methyl isobutyl ketone, ethyl acetate, butyl acetate, cyclohexanone, butyl alcohol, N,N-dimethylformamide, toluene, and mixtures thereof

Common binders include polyurethanes, non-halogenated vinyl copolymers, halogenated vinyl copolymers, and a combination thereof As used herein, the term “nonhalogenated” means that the copolymer contains no covalently bound halogen atoms. Thus, the term “nonhalogenated” excludes vinyl halide monomers such as vinyl chloride or vinylidene chloride as monomeric components of the copolymer, but the term “nonhalogenated” does not exclude monomeric components such as (meth)acryloyloxyethyl trimethylammonium chloride in which chlorine is present as a chloride anion. As used herein, the prefix “(meth)acryl-” means “methacryl-” or “acryl-.” The term “vinyl” with respect to a polymeric material means that the material comprises repeating units derived from vinyl monomers. As used with respect to a vinyl monomer, the term “vinyl” means that the monomer contains a moiety having a free-radically polymerizable carbon-carbon double bond. Monomers having such moieties are capable of copolymerization with each other via the carbon-carbon double bonds.

One useful polyurethane is a carboxyl polyurethane polymer, such as that described in U.S. Pat. No. 5,759,666 (Carlson et al.). The carboxyl polyurethane polymer typically comprises the reaction product of a mixture comprising: (i) one or more polyisocyanates, (ii) a carboxylic acid functional polyol, and, (iii) optionally one or more polyols defined to exclude the former carboxylic acid functional polyol, wherein the number of isocyanate-reactive groups present in the mixture prior to reaction exceeds the number of isocyanate groups and at least about 0.2 meq of carboxylic acid groups are present on the carboxyl polyurethane polymer per gram of carboxyl polyurethane polymer. Typically, the reaction product has a number average molecular weight from about 2000 to about 50,000, preferably from about 5000 to about 30,000.

The term “polyisocyanate” refers to any organic compound that has two or more reactive isocyanate (i.e., —NCO) groups in a single molecule that can be aliphatic, alicyclic, aromatic, and a combination thereof, and includes diisocyanates, triisocyanates, tetraisocyanates, etc., and combinations thereof Preferred polyisocyantes are the diisocyanates such as diphenylmethane diisocyanate, isophorone diisocyanate, toluene diisocyanate, hexamethylene diisocyanate, tetramethylxylene diisocyanate, p-phenylene diisocyanate, and combinations thereof

The term “polyol,” as used herein, refers to polyhydric alcohols containing an average of one or more hydroxyl groups and includes monohydric alcohols, diols, triols, tetrols, etc. Preferred polyols are diols that include both low molecular weight (i.e., having less than about 500 number average molecular weight) and oligomeric diols, typically having a number average molecular weight from about 500 to about 5000. Representative examples of low molecular weight diols include, but are not limited to, ethylene glycol, propylene glycol, diethylene glycol, diols having polar functional groups, diols bearing ethylenic unsaturation (e.g., 3-allyloxy-1,2-propandiol, 1-glyceryl (meth)acrylate, etc.) and fluorinated diols. Representative examples of oligomeric diols include, but are not limited to, polyether diols, polyester diols, polyether triols, and polyester triols.

Another useful polyurethane is a phosphonated polyurethane, such as described in U.S. Pat. No. 5,501,903 (Erkkila et al.). Preferably, the phosphonated polyurethane includes (i) nitrogen forming part of the backbone of the polymer, (ii) a single bond or divalent linking group (preferably including up to 4 linear carbon atoms), and (iii) two pendant groups independently selected from of an alkyl group, a cycloalkyl group, an aryl group, or together comprise the necessary carbon atoms to complete a ring. The phosphonated polyurethane is preferably formed by reaction of a soft segment diol in which the hydroxyl groups are separated by a flexible chain (typically having a molecular weight of more than 300 and often including a polycaprolactone diol, a hard segment diol in which the hydroxyl groups are separated by a relatively inflexible chain (typically having a molecular weight of less than 300 and often including neopentyl glycol, a triol (e.g., a polycaprolactone triol), a diisocyanate (e.g., toluene diisocyanate, 4,4-diphenylmethane diisocyanate, ocisophorene diisocyanate), and a dialkyl phosphonate (e.g., diethyl bis-(2-hydroxyethyl)aminomethylphosphonate).

An example of a useful quaternary ammonium-containing polyurethane is a polymeric quaternary ammonium compound described in U.S. Pat. No. 5,759,666 (Carlson et al.). In particular, preferred polymeric quaternary ammonium compounds have a number average molecular weight greater than about 500 and are selected from the group of quaternary ammonium polyurethanes, quaternary ammonium functional non-halogenated vinyl copolymers, and combinations thereof

A suitable binder may include quaternary ammonium functionality. As used herein, the term “quaternary ammonium functionality” refers to moieties of the formula

(*N(R)₃)⊕MΘ

wherein (i) the bond denoted with the asterisk is attached to the backbone of the polymeric binder resin either directly or indirectly through a difunctional linking group; (ii) each R may independently be any suitable moiety or co-member of a ring structure, and is preferably H or an alkyl group of 1 to 10 carbon atoms such as —CH₃; and (iii) M is any suitable counter anion such as Cl⁻, Br⁻, or the like. The term “quaternary ammonium functionality” also would encompass sulfobetaines, (e.g., —N⁺(CH₃)₂(CH₂CH₂CH₂SO₃⁻)).

In one embodiment, the quaternary ammonium functional polymer is a nonhalogenated vinyl copolymer which is incorporated into the polymeric binder as the “hard resin” component having a relatively high glass transition temperature (T_{g}).

In another embodiment, the nonhalogenated vinyl copolymer is of the type comprising a plurality of pendant quaternary ammonium groups, a plurality of pendant crosslinkable moieties such as OH groups or moieties having carbon-carbon double bonds, and a plurality of pendant nitrite groups. Without wishing to be bound by theory, it is believed that the nitrile groups may promote the compatibility of these vinyl copolymers with polyurethanes. It is also believed that the pendant hydroxyl groups of the vinyl copolymer not only facilitate dispersion of the magnetic particles in the polymeric binder, but also promote solubility, cure and compatibility with other polymers. The quaternary ammonium groups of the vinyl copolymer facilitate dispersion of the magnetic particles in the polymeric binder.

In yet another embodiment, the quaternary ammonium functional polymer is a quaternary ammonium polyurethane that has at least one quaternary ammonium group pendant from a polyurethane chain of molecular weight greater than about 500.

Another useful non-halogenated vinyl copolymer is one having a plurality of pendant nitrite groups, a plurality of pendant hydroxyl groups, and at least one pendant dispersing group, such as described in U.S. Pat. No. 5,501,903 (Erkkila et al.) and U.S. Pat. No. 5,510,187 (Kumar et al.). One such non-halogenated vinyl copolymer is comprised of (i) a nonhalogenated vinyl copolymer of monomers comprising 5 to 40, preferably 15 to 40, parts by weight of (meth)acrylonitrile; (ii) 30 to 80 parts by weight of one or more nonhalogenated, nondispersing, vinyl monomers; (iii) 1 to 30 parts by weight of a nonhalogenated, hydroxyl functional, vinyl monomer; and (iv) 0.25 to 10 parts by weight of a nonhalogenated, vinyl monomer bearing a dispersing group. The dispersing group can be selected from quaternary ammonium, acid or salt of carboxyl, acid or salt of phosphate or phosphonate, acid or salt of sulfate or sulfonate, and mixtures thereof When the dispersing group is quaternary ammonium, it is preferred that the vinyl monomer bearing a dispersing group is (meth)acryloyloxyethyl trimethylammonium chloride.

The nonhalogenated, nondispersing, vinyl monomer is preferably selected from styrene; an alkyl ester of (meth)acrylic acid wherein the alkyl group of the alkyl ester has 1 to 20 carbon atoms; and a blend comprising styrene and such an alkyl ester (e.g. methyl (meth)acrylate, more preferably methyl methacrylate), wherein the weight ratio of styrene to the alkyl ester is in the range from 10:90 to 90:10.

Halogenated vinyl copolymers are also useful as binders. These include vinyl chloride resins, vinyl chloride-vinyl acetate resins, vinyl chloride-vinyl acetate-vinyl alcohol resins, vinyl chloride-vinyl acetate-maleic anhydride resins, and combinations thereof, such as those described in U.S. Pat. No. 5,763,046 (Ejiri et al.). These resins preferably also include one or more bonded polar groups bonded. Preferred polar groups include SO₃M₁, COOM₁, OSO₃M₁, P═O(OM₂)O M₃, —OP═O(OM₂)OM₃, —NRX, OH, NR₁, NR₂ (wherein R is a hydrocarbon group), an epoxy group, SH, and CN. Another useful type of vinyl chloride resin is a vinyl chloride copolymer containing epoxy groups (e.g., a copolymer containing a vinyl chloride repeating unit, an epoxy-containing repeating unit, and, if desired, a polar group-containing unit (e.g., —SO₃M, —OSO₃M, —COOM, and —PO(OM)₂, wherein M is hydrogen or an alkali metal)). Of these, a copolymer containing a repeating epoxy group and a repeating unit containing —SO₃Na are particularly usefil.

The polymers mentioned above may be prepared by polymerization methods known in the art, including but not limited to bulk, solution, emulsion, and suspension free-radical polymerization methods. For example, according to the solution polymerization method, copolymers may be prepared by dissolving the desired monomers in an appropriate solvent, adding a chain-transfer agent, a free-radical polymerization initiator, and other additives known in the art, sealing the solution in an inert atmosphere such as nitrogen or argon, and then agitating the mixture at a temperature sufficient to activate the initiator.

Other Components

In addition to the binder and magnetic pigment, the magnetic layer may also include other components such as lubricants, abrasives, thermal stabilizers, catalysts, crosslinkers, antioxidants, dispersants, wetting agents, head-cleaning agents, fungicides, bactericides, surfactants, antistatic agents, nonmagnetic pigments, coating aids, surface treatment agents, and the like.

One preferred type of crosslinker is a polyisocyanate crosslinker known to the magnetic recording media art to cure at a glass transition temperature of greater than about 100° C. useful for production layers of high glass transition temperature and hardness. A particularly useful type of polyisocyanate crosslinker is the reaction product of an excess of a diisocyanate with low number average molecular weight (i.e., under about 200) diols and triols. A typical and widely used polyisocyante crosslinker comprises the adduct of toluene diisocyanate with a mixture of trimethylol propane and a diol such as butane diol or diethylene glycol. A preferred material of this type is available under the trade designation MONDUR CB-55N from Bayer Corporation. Other useful high T_{g} crosslinkers are available under the trade designations MONDUR CB-601, MONDUR CB-701, MONDUR MRS, and DESMODUR L (all available from Bayer Corporation), and CORONATE L (available from Nippon Polyurethane). Additional isocyanate crosslinking agents are described in U.S. Pat. No. 4,731,292 (Sasaki et al.).

A toughened polyisocyanate crosslinker which cures to a tough and flexible, rather than a brittle, film may be desirable for some applications. Useful toughened polyisocyanate crosslinkers are described in U.S. Pat. No. 5,759,666 (Carlson et al.) and are obtained as the reaction product of an excess of a polyisocyanate with polyols, including 10-80% by weight of an oligomeric polyol which acts as a toughening segment. The oligomeric polyols useful in making toughened polyisocyanate curatives have a number average molecular weight of about 500 to about 5000 and a glass transition temperature of lower than about 0° C., preferably lower than about minus 20° C. The oligomeric polyols are preferably selected from the group consisting of polyester diols, polyester triols, polyether diols, polyether triols, polycarbonate diols, polycarbonate triols, and mixtures thereof

One of the preferred toughened polyisocyanate crosslinkers is made from the reaction product of MONDUR CB-55N with 45 weight percent of a polycaprolactone diol of 1300 number average molecular weight. This modified MONDUR CB-55N provides a faster cure and a tougher coating. The modified MONDUR CB-55N may be used at a loading of between about 20 and about 60 weight percent, most preferably about 30 to about 50 weight percent, based upon the weight of formulation solids exclusive of particles.

Suitable lubricants include those disclosed in U.S. Pat. No. 4,731,292 (Sasaki et al.), U.S. Pat. No. 4,784,907 (Matsufuji et al.), and U.S. Pat. No. 5,763,076 (Ejiri et al.). Such lubricants can provide desired frictional and processing characteristics. Specific examples of useful lubricants include but are not limited to those selected from the group consisting of C₁₀ to C₂₂ fatty acids, C₁ to C₁₈ alkyl esters of fatty acids, and mixtures thereof Other useful lubricants include silicone compounds such as silicone oils, fluorochemical lubricants, and fluorosilicones; and particulate lubricants such as powders of inorganic or plastic materials. Commonly preferred lubricants include myristic acid, stearic acid, palmitic acid, isocetyl stearate, oleic acid, and butyl and amyl esters thereof Mixtures of lubricants are often used, especially mixtures of fatty acids and fatty esters.

A suitable type of wetting agent are phosphoric acid esters such as monophosphorylated propylene oxide adducts of glycerol (e.g., the reaction product of 1 mole of phosphorous oxychloride with the reaction product of 10-11 moles of propylene oxide and 1 mole of glycerine).

Suitable head cleaning agents include but are not limited to those disclosed in U.S. Pat. No. 4,784,914 (Matsufuji et al.) and U.S. Pat. No. 4,731,292 (Sasaki et al.). Specific examples of useful cleaning agents include, but are not limited to, alumina, chromium dioxide, alpha iron oxide, and titanium dioxide particles of a size less than about 2 microns, preferably less than 0.5 microns, which have a Mohs hardness of greater than about 5 and which are added in an amount ranging from about 0.2 to about 20 parts per hundred parts of magnetic particles.

### Method of Making Particulate Magnetic Recording Media

An information storing layer incorporating surface treated magnetic pigment of the present invention may be prepared using a variety of approaches. Generally, the magnetic pigment initially is combined with the surface treatment agents and a suitable solvent, and the resultant admixture is aggressively mixed in order to break up agglomerates of magnetic particles and allow the surface treatment agent to be adsorbed onto the surface of the particles. The surface treated particles are then combined with the other components of the information storing layer along with a suitable solvent and mixed to form a substantially homogeneous dispersion. When the magnetic pigment is a metal powder, possessing is generally effected under an inert atmosphere (e.g., N₂) in order to prevent undesired oxidation of the magnetic pigment. Inert atmosphere means an atmosphere comprised predominantly of an inert gas such as nitrogen or a noble gas, and having an oxygen content of less than 500 parts per million. A preferred inert atmosphere is N₂ having an oxygen content of less than 75 parts per million.

The dispersion is then coated onto a substrate, which may be primed or unprimed and which may also optionally already bear another magnetizable or nonmagnetic layer in the event that the magnetic recording medium is to be a ““multiple layer” magnetic recording medium. The dispersion may be applied to the substrate using any conventional coating technique, such as gravure or knife coating techniques. The coated substrate may then be passed through a magnetic field in order to orient or randomize the magnetic pigment, after which the coating is dried, calendered if desired, and then allowed to cure.

Curing can be accomplished in a variety of ways. One approach useful with those polymeric binders having an excess of isocyanate reactive groups (e.g., —OH) is incorporation of an isocyanate crosslinking agent into the dispersion just before the dispersion is coated onto the substrate. As soon as the isocyanate crosslinking agent is added to the dispersion, the NCO groups of the isocyanate crosslinking agent will begin to react with the hydroxyl groups of the polymeric binder. Preferably, a catalyst (e.g., dibutyltin dilaurate) may also be added in suitable catalytic amounts in order to facilitate this crosslinking reaction. Generally, incorporation of from 0.02 to 0.2 parts by weight of catalyst per 100 parts by weight of magnetic pigment has been found to be suitable in the practice of the present invention.

Suitable isocyanate crosslinking agents include polyfunctional isocyanates having an average functionality of at least 2 isocyanate groups per molecule. Examples of specific polyfunctional isocyanates useful as the isocyanate crosslinking agent in the practice of the present invention include materials commercially available as MONDUR CB-601, CB-75, CB-701, MONDUR-MRS from Miles, Inc.; DESMODUR L available Bayer A.G.; CORONATE L from Nippon Polyurethane Ind., Ltd.; and PAPI from Union Carbide Corp. A particularly preferred crosslinker is a “toughened polyisocyanate activator” (TPA). One useful TPA is obtained as the reaction product of an excess of a polyisocyanate with polyols, including 10-80% by weight of an oligomeric polyol which acts as a toughening segment. The oligomeric polyols useful in making toughened polyisocyanate curatives have a number average molecular weight of about 500 to about 5000 and a glass transition temperature of lower than about 0° C., preferably lower than about −20° C.

One particularly preferred toughened polyisocyanate activator is made from the reaction product of CB55N (MONDUR CB-55N from Bayer Corporation) with 45 weight percent of a polycaprolactone diol of 1300 number average molecular weight. This modification of CB-55N provides a faster cure and a tougher coating.

The isocyanate crosslinking agent is preferably used in an amount such that the molar ratio of NCO groups from the isocyanate crosslinking agent to the total number of hydroxy groups from the hydroxy functional polymer is greater than 0. Preferably, the molar ratio of the NCO groups from the isocyanate crosslinking agent to the total number of hydroxy groups from the hydroxy functional polymer (i.e., activation index) is in the range from 0.3 to 6, more preferably 0.5 to 4.

As another approach, when one or more components of the polymeric binder contain radiation curable moieties, the dried coating may be irradiated to achieve curing of the radiation curable materials. Irradiation may be achieved using any type of ionizing radiation (e.g., electron beam radiation or ultraviolet radiation) in accordance with practices known in the art. Preferably, radiation curing is achieved with an amount of electron beam radiation in the range from 1 to 20 Mrads, preferably 4 to 12 Mrads, and more preferably 5 to 9 Mrads of electron beam radiation having an energy in the range from 100 to 400 keV, preferably 200 to 250 keV. Although electron beam irradiation can occur under ambient conditions, it is preferred to use an inert atmosphere as a safety measure in order to keep ozone levels to a minimum and to increase curing efficiency.

Traditionally, radiation curable formulations have most commonly relied upon the reactivity of acrylates, methacrylates, and the like to achieve radiation-induced crosslinking. Unfortunately, however, magnetic dispersions prepared from such materials tend to undergo unwanted crosslinking reactions under ambient conditions so as to form gels, particularly when the magnetic pigment is a metal particle pigment. These dispersions are especially prone to suffer from undesirable crosslinking during dispersion milling. However, because radiation curable polymers having dispersing groups are capable of wetting/dispersing the magnetic pigment, it is desirable to include at least some of such polymers in the milling step. In order to accomplish this, radiation curable (meth)acrylate groups may be replaced by allyloxy groups (e.g., —O—CH₂—O—CH═CH₂), or a-methyl styrene moiety of the formula

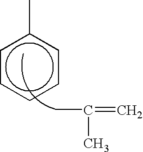

as such dispersing groups are more stable to the milling process than (meth)acrylate groups.

According to a particularly preferred approach for making a magnetic recording medium of the present invention incorporating a metal powder magnetic pigment, the metal powder magnetic pigment, the surface treatment agents, and solvent are combined in a kneader or other high energy mixer (such as a double planetary mixer) under a blanket of N sub2. The ingredients are mixed for a sufficient time, typically 10 to 30 minutes, to achieve good surface treatment of the pigment.

Advantageously, the progress of the surface treatment can be followed by monitoring the torque and/or power draw of the kneader, or other mixer as the case may be, as a function of time. Initially, kneader torque (or power draw) tends to oscillate between minimum and maximum values. As mixing continues, and the surface treatment agents are adsorbed onto the surface of the pigment, the amplitude of the oscillations decreases and eventually the torque (or power draw) curve settles down to a relatively flat profile. After the torque (or power draw) curve flattens, surface treatment is typically completed sufficiently for good dispersion and superior retention of the surface particles within the information storage layer.

The solvent for surface treatment is used in an amount sufficient to wet the surfaces of the pigment yet limited so as to provide an admixture of solvent, magnetic pigment, and surface treatment agents with a powder-like consistency. A variety of solvents could be used to accomplish surface treatment. Desirably, a solvent is selected which is compatible with the surface treatment agents and the other components, particularly the polymeric binder, to be incorporated into the information storing layer. Solvents useful for dilution of the pigment admixture include (i) ketones such as acetone, methyl ethyl ketone (MEK), methyl isobutyl ketone (MIBK), cyclohexanone, and isophorone; (ii) esters such as methyl acetate, ethyl acetate, butyl acetate, isobutyl acetate, isopropyl acetate, ethyl lactate, and glycol monoethyl ether acetates; (iii) ethers such as diethyl ether, tetrahydrofuran (THF), glycol dimethyl ethers, and dioxane; (iv) aromatic hydrocarbons such as benzene, toluene, xylene, cresol, chlorobenzene, and styrene; (v) chlorinated hydrocarbons such as methylene chloride, ethylene chloride, carbon tetrachloride, chloroform, ethylene chlorohydrin, and dichlorobenzene; (vi) N,N-dimethylformamide; and (vii) hexane. Preferred solvents include tetrahydrofuran (THF), methyl ethyl ketone (MEK), methyl isobutyl ketone (MIBK), cyclohexanone, toluene, combinations of these, and the like.

After surface treatment is completed to the degree desired, a solution comprising solvent and at least a portion of the uncured polymeric binder resin(s) is added. The portion of binder resins to be added is not particularly critical, and only a portion, or even all, of the binder resin(s) could be added at this point. However, adding only a portion of the binder resin(s) at this point may provide processing advantages. The amount of binder resin to add in the initial blending should be sufficient to achieve good dispersion of the surface treated particles with minimal solvent. Accordingly, as a general proposition adding approximately half the binder resin(s) upon initial blending of the surface treated particles into the binder, along with sufficient solvent to dilute the blend to a solids content of about 20% to 50%, preferably 25% to 50%, is desired. Solvents useful for dilution of the polymer blend include (i) ketones such as acetone, methyl ethyl ketone (MEK), methyl isobutyl ketone (MIBK), cyclohexanone, and isophorone; (ii) esters such as methyl acetate, ethyl acetate, butyl acetate, isobutyl acetate, isopropyl acetate, ethyl lactate, and glycol monoethyl ether acetates; (iii) ethers such as diethyl ether, tetrahydrofuran (THF), glycol dimethyl ethers, and dioxane; (iv) aromatic hydrocarbons such as benzene, toluene, xylene, cresol, chlorobenzene, and styrene; (v) chlorinated hydrocarbons such as methylene chloride, ethylene chloride, carbon tetrachloride, chloroform, ethylene chlorohydrin, and dichlorobenzene; (vi) N,N-dimethylforrnamide; and (vii) hexane. A solvent blend of 40 parts by weight MEK, 30 parts by weight THF, and 30 parts by weight MIBK has been found to be suitable in the practice of the present invention.

Blending progress may be monitored by monitoring the torque and/or power draw of the kneader, or other mixer as the case may be, and/or the temperature of the polymer solution as a function of time. Optimal blending of the polymer solution should produce a spike in the monitored parameter within 2 seconds to 30 minutes. If no such spike is observed after about 15 to 30 minutes, additional solvent should be added until such a spike is observed. Typically, adding enough additional solvent to drop the solids content to about 65% to about 70% solids is typically sufficient to cause the spike to occur. The spike indicates that the polymer/solvent phase of the admixture has become a continuous phase and now has viscoelastic properties. After the spike occurs, the measured parameter tends to plateau. In some instances, particularly when temperature is the measured parameter, the plateau may have a slight positive slope. Mixing is desirably allowed to continue a defined amount of time, e.g., 5 minutes to 2 hours, after the spike occurs. Longer mixing times are generally used with larger scale equipment.

After mixing is completed, the resulting dispersion can be transferred to a media mill where a 20% to 60%, preferably 25% to 50%, solids solution of the remaining binder resin(s), if any, in a solvent such as that defined above, is added to the mill. If necessary, additional solvent as defined above with respect to the polymer solution is added to bring the total solids content to about 35% to 50% by weight. The combined ingredients can then be milled until substantially homogeneous. Typically, milling is continued until no further changes in the surface gloss of handspread samples are observed and/or until no large agglomerates are observed when a dispersion sample is smeared onto a glass slide and viewed under an optical microscope at a magnification of about 100× to 500×. The type of milling media used is not critical and may be stainless steel, ceramic, or the like.

Once the dispersion is homogeneous, the other ingredients of the information-storing layer can be milled or blended into the dispersion. If blending is used, the ingredients may be transferred to a suitable high shear mixer or shaker, or the like, in order to accomplish blending.

The dispersion may then be coated onto the substrate, dried and oriented. These steps may occur either in a sequence of steps or in a single step. For example, in a sequence of steps, the wet, coated information storing layer can be passed first through a magnetic orientation field (e.g., a magnetic field of about 1500 to 1600 gauss) and then dried. Alternatively, the wet, coated layer can be simultaneously dried and oriented in a magnetic orientation field (e.g., a magnetic field of about 6000 gauss). With either approach, drying may be accomplished under any suitable conditions, including drying under ambient conditions, drying in an oven, or an oven purged with inert gas. Optionally, the information storing layer can then be calendered after drying.

For certain applications it may be desirable to employ surface treated nonmagnetizable particles in a coating composition that is not required to possess magnetic properties, such as a primer/adhesion promotion layer, an activator layer, a sublayer (typically located between the magnetic layer and the substrate), or a protective top layer. For example, a sublayer coating composition can comprise non-magnetizable particles, such as carbon black, alpha-iron oxide, aluminum oxide, titanium dioxide, zinc oxide, silica gel, calcium carbonate, barium sulfate, and mixtures thereof which have been surface treated in accordance with this invention.

The present invention will now be further described with reference to the following examples.

Testing Protocols

Coecivity (H_{c})

Coercivity measures the strength of the magnetic field required to switch the magnetization of the magnetic particles in the coating measured in Oe. Magnetic measurements were obtained using a LDJ M-H Meter operating at 6,000 Oe and 60 Hz.

Squareness (Sq)

Squareness is the ratio of the magnetic flux remaining after removal of an applied magnetic field to the magnetic flux present at an applied saturating magnetic field. Magnetic measurements were obtained using a LDJ M-H Meter operating at 6,000 Oe and 60 Hz.

Switching Field Distribution (SFD)

Switching Field Distribution is a measure of the dispensability of the magnetic pigment particles. Switching Field Distribution of a ferromagnetic metal powder itself should be small, preferably less than 1.0, more preferably less than 0.6. When the SFD is less than 1.0, electromagnetic characteristics are excellent, high output can be obtained, reversal of magnetization becomes sharp and peak shift is less, rendering the recording media suitable for high density digital magnetic recording.

Orientation Ratio

Orientation ratio is calculated by dividing down web Sq values by cross web Sq values obtained from a sample.

Rodenstock

Rodenstock value is a measure of smoothness of a coating. Rodenstock was measured using a Rodenstock RM-400 surface finish analyzer commercially available from Rodenstock Co. Generally, a lower Rodenstock value corresponds to a smoother surface.

Gloss

Gloss is a measure of the refractive index and roughness of a surface. High values of surface gloss are indicative of well dispersed pigment coatings. Surface gloss was measured at a 45° angle using a Gardner gloss meter and reported as a percentage of the source light reflected by the surface.

Modulus (E′)

Modulus (E′) is Youngs Modulus measured with a Seiko DMA-210 tension module at a temperature scan interval of −20° C. to 160° C., heating rate of 3° C./min and a frequency of 1 Hz. Testing was conducted upon substrate only and coated substrate, with data obtained for the coating through a subtraction program.

Tg (E″)

Glass transition temperature (Tg) is derived in ° C. from the loss modulus peak obtained from modulus testing.

Storage Modulus (G′)

Storage Modulus (G′) was measured with a Seiko DMA at a temperature scan interval of −20° C. to 150° C., heating rate of 3° C./min and a frequency of 1 Hz with a minimum tension of 80 m Newtons.

Relative Susceptibility

Relative Susceptibility is a measure of dispersability. Relative susceptibility is measured using a susceptometer consisting of two mutually compensated, oppositely wound internal (pick-up and back-up) coils, encompassed by a larger external coil. A sample dispersion in a 3 cc syringe is inserted into the pick-up coil. An AC input voltage V₁=V₁₀sin (ωt) of angular frequency ω is applied to the external coil inducing an output voltage V₂=V₂₀sin (ωt+φ) in the circuit of internal coils. From the amplitude signal ratio ν₀=V₂₀/V₁₀, and the phase shift φ, a complex relative susceptibility χᵣ=Xᵣ′−iχᵣ″ is calculated. For a liquid sample (in which particles can move), it generally has real and imaginary parts χᵣ′ and χᵣ″, while for a dry sample (in which particles are immobilized), such as a dry magnetic powder, it may be assumed to have only the real part, which is taken as 1. Thus, the relative susceptibility is defined as the ratio of the susceptibility of the liquid mix to the susceptibility of the dry powder, both taken per one magnetic particle. A dry powder sample used as a reference has to contain the same particles as those in the liquid mix. Real and imaginary parts of the relative susceptibility are calculated utilizing equations (1).

$$\begin{matrix}{χ}_{r}^{′} = \frac{{v}_{0}}{{v}_{0 p}} \frac{{w}_{p}}{w c} \frac{( tan ϕ + ω λ )}{ω λ \sqrt{1 + {tan}^{2} ϕ}} \\ {χ}_{r}^{″} = \frac{{v}_{0}}{{v}_{0 p}} \frac{{w}_{p}}{w c} \frac{( 1 - ω λ tan ϕ )}{ω λ \sqrt{1 + {tan}^{2} ϕ}}\end{matrix} \qquad ( 1 )$$

where w is the weight of the sample, c is the weight fraction of magnetic particles in the sample, wₚ is the weight of the powder sample used for calibration, ν₀ₚ is the voltage ratio for the reference sample, and λ is a constant (specific for the circuit).

The testing protocol includes three steps. First, a powder (reference) sample is tested, (i.e., the functions ν₀(ω) and φ(ω) are measured for the powder). These functions are fitted to equations (1) so as to make the susceptibility of the powder close to 1. To this end (χᵣ′(ω)−1)²+(χᵣ″(ω))² is minimized. This procedure yields the fitting parameters ν₀ₚ and λ. Next, the functions ν₀(ω) and φ(ω) of the liquid sample are measured. The real and imaginary parts of the relative susceptibility are calculated according to equations (1) from these functions as functions of the angular frequency χᵣ′(ω) and χᵣ″(ω). Finally, these functions are used to calculate the low-frequency relative susceptibility limit χᵣ₀, and the characteristic relaxation time τ_{c}, defined by the following equations:

$$\begin{matrix}{χ}_{r}^{′} = 1 + {\int }_{0}^{∞} \frac{ⅆ τ}{τ} L ( τ ) \frac{1}{1 + {( ω τ )}^{2}} , \\ {χ}_{r}^{″} = {\int }_{0}^{∞} \frac{ⅆ τ}{τ} L ( τ ) \frac{( ω τ )}{1 + {( ω τ )}^{2}} ,\end{matrix} \qquad ( 2 )$$

were the following parametric representation for the relaxation spectrum, L(τ), is used

$$L ( τ ) ≡ 0.2 ( {χ}_{r0} - 1 ) \frac{\frac{τ}{{τ}_{c}}}{{( 1 + \frac{τ}{{τ}_{c}} )}^{1.2}} . \qquad ( 3 )$$

Equations (2) and (3) provide a good fit and allow extrapolation of the experimental functions χᵣ′(ω) and χᵣ″(ω) to a single parameter χᵣ₀ which is referenced simply as “relative susceptibility”. This parameter characterizes mobility of magnetic particles in magnetic mixes. A higher χᵣ₀ indicates a higher particle mobility and thereby suggests better dispersion of the particles. For a dry powder or a very poorly dispersed mix, in which particles do not move, χᵣ₀ approaches 1.

Hardness

Hardness was measured with a UMIS 2000 Nanoindentation Instrument manufactured by CSIRO of Australia using a 5 μm diameter diamond tipped indenter at a contact force of 0.02 m Newtons and a maximum force of 0.2 m Newtons.

Loop Test (Debris)

Durability of an image layer can be evaluated by the debris loop testing method. A 33″ length of the sample magnetic recording tape is spliced and placed upon a loop tester equipped with a ceramic pin. The tape is passed approximately 3,000 times against the ceramic pin at a tension of 3 oz. Upon completion, the debris collected on the ceramic pin is removed with transparent tape and both the collected debris and the loop of magnetic recording tape are visually rated on a scale of 0 to 10 with 0 constituting no debris and a visually undamaged loop. The test was conducted at room temperature and at under elevated temperature and humidity conditions of 40° C. and 80% RH.

Loop Test (Friction)

Durability of an image layer can be evaluated by the friction loop testing method. A 33″ length of the sample magnetic recording tape is spliced and placed upon a loop tester equipped with a DLT-4 head. The tape is passed approximately 3,000 times against the DLT-4 head and the frictional force generated at the head is measured. The test was conducted at room temperature and at under elevated temperature and humidity conditions of 40° C. and 80% RH. Both debris and friction loop tests may be run simultaneously on a single sample.

Glossary of Components

| ABBREVIATION | DESCRIPTION |
|---|---|
| Pigment Particles | |
| Al₂O₃ | Aluminum oxide |
| BP-2000 | Carbon black available from Cabot of |
| | Boston, Massachusetts. |
| DBN-650RX | Nonmagnetic iron oxide available from Toda |
| | Kogyo of Hiroshima, Japan |
| D3-101 | Ferromagnetic metal particle pigments |
| | (MP-2) available from Dowa Mining Co., |
| | Ltd., Tokyo, Japan. |
| HM-94 | Ferromagnetic metal particle pigments |
| | (MP-3) available from Dowa Mining Co., |
| | Ltd., Tokyo, Japan. |
| HM-101 | Ferromagnetic metal particle pigments |
| | (MP-2) available from Dowa Mining Co., |
| | Ltd., Tokyo, Japan. |
| TiO₂ | Titanium dioxide |
| Surface Treatment Agents | |
| HMPA | Hydroxymethyl phosphonic acid |
| 4-NBA | 4-nitrobenzoic acid |
| Binder Components | |
| Activators | |
| PPA-45 | Isocyanate activator available from |
| | Minnesota Mining and Manufacturing Com- |
| | pany of St. Paul, Minnesota |
| CB-55A | MONDUR CB-55 ™ a polyfunctional |
| | isocyanate crosslinking agent available from |
| | Bayer Corporation |
| Hard Resin Component | |
| NHVC (K32) | Nonhalogenated vinyl copolymer containing |
| | (i) 72.4 wt % styrene, (ii) 24.1 wt % acrylo- |
| | nitrile, (iii) 2.5 wt % 2-hydroxy propyl |
| | acrylate, and (iv) 1 wt % methacryloxy |
| | oxyethyl trimethyl ammonium chloride |
| MR-108 | Polyvinyl chloride available from Zeon |
| | Corporation of Tokyo, Japan. |
| Soft Resin Component | |
| PU(COOH) | A graft carboxyl polyurethane as disclosed in |
| | Example 6 of U.S. Pat. No. 5,874,502. |
| PU(COOH)_{low} | A graft carboxyl polyurethane as disclosed in |
| | Example 6 of U.S. Pat. No. 5,874,502 with |
| | the inclusion of 2,2-dimethylpropane-1,3- |
| | diol, also known as neopentyl glycol |
| | (NPG), and a lower acid functionality. |
| UR-4122 | Polyurethane resin available from Toyobo |
| | Co., Ltd. |
| UR-7300 | Polyurethane resin available from Toyobo |
| | Co., Ltd. |
| Solvents | |
| MEK | Methyl ethyl ketone |
| THF | Tetrahydrofuran |

Experimental

Into a container containing steel beads or ceramic beads (about 0.8 to 1.0 mm in diameter) was sequentially added solvent, surface treatment agents, and magnetic pigment. The pigment mixture was mixed and then shaken for 60 minutes. Into the shaken pigment mixture was sequentially added a hard resin binder component and sufficient solvent to dilute the first polymer mixture to 50% solids. The first polymer mixture was shaken for 3 hours. Into the shaken first polymer mixture was sequentially added a soft resin binder component and sufficient solvent to dilute the second polymer mixture to 40% solids. The second polymer mixture was shaken for 2 hours. The second polymer mixture was allowed to cool to room temperature and then an activator, a lubricant and sufficient solvent to dilute the final mixture to 30% solids was added to the second mixture to form a final mixture. The final mixture was shaken for 30 minutes, removed from the container, and screen separated from the milling media to form a dispersion.

The dispersion was coated onto a polyethylene terephthalate backing film using a knife coater and the magnetic particles in the coating magnetically aligned by pulling the coated film through a 6 K magnetic field immediately after coating of the dispersion onto the film.

The coating was allowed to dry under ambient conditions, calendered and cured using conventional techniques (i.e., heat treated at 60° C. for 72 hours). The surface characteristics and/or bulk magnetic and electromagnetic performance characteristics of the cured coating was tested.

The specific types and amounts of magnetic pigment, surface treatment agents, hard vinyl resin, and soft polyurethane resin used to form the dispersion of each example is set forth in Table One, wherein a notation of “- - - ” indicates that the specified component was not incorporated into the dispersion. The equivalent weight ratio of hard resin binder to soft resin binder in the dispersion was 1:1. The weight ratio of polymers (i.e., hard and soft resin binders) to PPA-45 was 2:1. The weight ratio of polymers to magnetic pigment was 2.71:16. The weight of surface treatment agents was based upon weight of pigment.

The bulk mechanical, magnetic and electromagnetic performance characteristics of each example, are reported in Table Two, including Coercivity (H_{c}), Squareness (Sq), Switching Field Distribution (SFD), Orientation Ratio, Rodenstock, Gloss (45°), Modulus (E′), Tg (E″) and Relative Susceptibility, wherein a notation of “- - - ” indicates that the specified characteristic was not tested.

Durability, as measured by the loop test, was measured for selected examples. Results are reported in Table Three.

TABLE ONE
Compositions

| | Surface | | | Binder | |
|---|---|---|---|---|---|
| | Treatment Agent | | Metal | Components | |
| | 4-NBA | HMPA | Particle | Hard Resin | Soft Resin |
| Sample # | (wt %) | (wt %) | (type) | (type) | (type) |
| A-1 | 4.0 | 0.0 | D3-101 | NHVC | PU(COOH) |
| A-2 | 3.8 | 0.2 | D3-101 | NHVC | PU(COOH) |
| A-3 | 3.6 | 0.4 | D3-101 | NHVC | PU(COOH) |
| A-4 | 3.5 | 0.5 | D3-101 | NHVC | PU(COOH) |
| A-5 | 3.4 | 0.6 | D3-101 | NHVC | PU(COOH) |
| A-6 | 3.2 | 0.8 | D3-101 | NHVC | PU(COOH) |
| A-7 | 3.0 | 1.0 | D3-101 | NHVC | PU(COOH) |
| B-1 | 4.0 | 0.0 | D3-101 | NHVC | PU(COOH) |
| B-2 | 3.85 | 0.15 | D3-101 | NHVC | PU(COOH) |
| B-3 | 3.7 | 0.30 | D3-101 | NHVC | PU(COOH) |
| B-4 | 3.55 | 0.45 | D3-101 | NHVC | PU(COOH) |
| B-5 | 3.4 | 0.60 | D3-101 | NHVC | PU(COOH) |
| B-6 | 3.25 | 0.75 | D3-101 | NHVC | PU(COOH) |
| B-7 | 3.1 | 0.90 | D3-101 | NHVC | PU(COOH) |
| B-8 | 3.0 | 1.0 | D3-101 | NHVC | PU(COOH) |
| C-1 | 4.0 | 0.0 | HM-101 | NHVC | PU(COOH) |
| C-2 | 3.5 | 0.5 | HM-101 | NHVC | PU(COOH) |
| C-3 | 3.0 | 1.0 | HM-101 | NHVC | PU(COOH) |
| C-4 | 2.5 | 1.5 | HM-101 | NHVC | PU(COOH) |
| C-5 | 2.0 | 2.0 | HM-101 | NHVC | PU(COOH) |
| D-1 | 4.0 | 0.0 | HM-101 | NHVC | PU(COOH) |
| D-2 | 3.5 | 0.5 | HM-101 | NHVC | PU(COOH) |
| D-3 | 3.0 | 1.0 | HM-101 | NHVC | PU(COOH) |
| D-4 | 2.5 | 1.5 | HM-101 | NHVC | PU(COOH) |
| E-1 | 2.0 | 0.0 | HM-94 | NHVC | PU(COOH) |
| E-2 | 3.0 | 0.0 | HM-94 | NHVC | PU(COOH) |
| E-3 | 4.0 | 0.0 | HM-94 | NHVC | PU(COOH) |
| E-4 | 5.0 | 0.0 | HM-94 | NHVC | PU(COOH) |
| E-5 | 0.0 | 2.0 | HM-94 | NHVC | PU(COOH) |
| E-6 | 0.0 | 3.0 | HM-94 | NHVC | PU(COOH) |
| E-7 | 0.0 | 4.0 | HM-94 | NHVC | PU(COOH) |
| E-8 | 0.0 | 5.0 | HM-94 | NHVC | PU(COOH) |
| E-9 | 3.8 | 0.3 | HM-94 | NHVC | PU(COOH) |
| E-10 | 3.5 | 0.5 | HM-94 | NHVC | PU(COOH) |
| E-11 | 3.3 | 0.8 | HM-94 | NHVC | PU(COOH) |
| E-12 | 3.0 | 1.0 | HM-94 | NHVC | PU(COOH) |
| F-1 | 4.0 | 0.0 | HM-94 | NHVC | PU(COOH)_{low} |
| F-2 | 3.9 | 0.2 | HM-94 | NHVC | PU(COOH)_{low} |
| F-3 | 3.8 | 0.3 | HM-94 | NHVC | PU(COOH)_{low} |
| F-4 | 3.5 | 0.5 | HM-94 | NHVC | PU(COOH)_{low} |
| F-5 | 3.3 | 1.8 | HM-94 | NHVC | PU(COOH)_{low} |
| F-6 | 3.0 | 1.0 | HM-94 | NHVC | PU(COOH)_{low} |
| F-7 | 2.8 | 1.3 | HM-94 | NHVC | PU(COOH)_{low} |
| G-1 | 4.0 | 0.0 | HM-94 | NHVC | UR-7300 |
| G-2 | 3.9 | 0.2 | HM-94 | NHVC | UR-7300 |
| G-3 | 3.8 | 0.3 | HM-94 | NHVC | UR-7300 |
| G-4 | 3.5 | 0.5 | HM-94 | NHVC | UR-7300 |
| G-5 | 3.3 | 1.8 | HM-94 | NHVC | UR-7300 |
| G-6 | 3.0 | 1.0 | HM-94 | NHVC | UR-7300 |
| G-7 | 2.8 | 1.3 | HM-94 | NHVC | UR-7300 |
| H-1 | 3.8 | 0.0 | HM-94 | MR-108 | UR-4122 |
| H-2 | 3.8 | 0.2 | HM-94 | MR-108 | UR-4122 |
| H-3 | 3.7 | 0.4 | HM-94 | MR-108 | UR-4122 |
| H-4 | 3.5 | 0.5 | HM-94 | MR-108 | UR-4122 |
| H-5 | 3.4 | 0.7 | HM-94 | MR-108 | UR-4122 |
| H-6 | 3.2 | 0.8 | HM-94 | MR-108 | UR-4122 |
| H-7 | 3.0 | 1.0 | HM-94 | MR-108 | UR-4122 |
| H-8 | 2.8 | 1.2 | HM-94 | MR-108 | UR-4122 |
| I-1* | 4.0 | 0.0 | HM-101 | NHVC | PU(COOH) |
| I-2* | 3.5 | 0.5 | HM-101 | NHVC | PU(COOH) |
| I-3 | 0.0 | 0.0 | HM-101 | NHVC | PU(COOH) |
| I-4^{#} | 4.0 | 0.0 | HM-101 | NHVC | PU(COOH) |
| I-5^{##} | 3.5 | 0.5 | HM-101 | NHVC | PU(COOH) |

*= top coat of dual layer coating
^{#}= dual layer coating with 4-NBA in top layer only
^{##}= dual layer coating with HMPA in top layer only

TABLE TWO
Characteristics

| | | | | Orientation | | | Modulus | Tg | Storage | | |
|---|---|---|---|---|---|---|---|---|---|---|---|
| Sample | | | | Ratio | Rodenstock | Gloss | (E′) | (E″) | Modulus | Relative | Hardness |
| # | Hc | Sq | SFD | (Phi/Phr) | (nm) | (45°) | (Gpa) | (Gpa) | (Gpa) | Susceptibility | (MPa) |
| A-1 | 1774 | 0.805 | 0.56 | 1.91 | 9.5 | 55 | 6.4 | 98 | — | 9.9 | — |
| A-2 | 1782 | 0.815 | 0.55 | 1.97 | 9.8 | 56 | 10.6 | 86 | — | 11.3 | — |
| A-3 | 1798 | 0.825 | 0.54 | 2.08 | 8.9 | 58 | 11.3 | 84 | — | — | — |
| A-4 | 1804 | 0.839 | 0.55 | 2.22 | 6.5 | 72 | 12.1 | 84 | — | 15 | — |
| A-5 | 1790 | 0.836 | 0.56 | 2.14 | 6.6 | 71 | 13.1 | 84 | — | 14.1 | — |
| A-6 | 1787 | 0.833 | 0.57 | 2.17 | 6.5 | 70 | 10.7 | 84 | — | 12.8 | — |
| A-7 | 1762 | 0.828 | 0.56 | 2.20 | 6.4 | 65 | 9.9 | 84 | — | 12.1 | — |
| B-1 | 1761 | 0.812 | 0.57 | 2.04 | 11.1 | 46 | 5.3 | 108 | — | 7.2 | — |
| B-2 | 1769 | 0.817 | 0.55 | 2.03 | 10.1 | 48 | 8.8 | 96 | — | 8.5 | — |
| B-3 | 1759 | 0.825 | 0.54 | 2.03 | 10.1 | 45 | 9.3 | 90 | — | 10.5 | — |
| B-4 | 1786 | 0.830 | 0.55 | 2.13 | 10.1 | 48 | 9.6 | 90 | — | 12.3 | — |
| B-5 | 1781 | 0.822 | 0.57 | 2.08 | 14.1 | 38 | 9.6 | 90 | — | 9.2 | — |
| B-6 | 1776 | 0.819 | 0.55 | 2.13 | 14.3 | 37 | 9.0 | 90 | — | 8.2 | — |
| B-7 | 1750 | 0.821 | 0.56 | 2.01 | 18.2 | 32 | 9.4 | 92 | — | — | — |
| B-8 | 1780 | 0.821 | 0.57 | 2.14 | 19.4 | 34 | 3.7 | 90 | — | — | — |
| C-1 | 1775 | 0.837 | 0.54 | 2.27 | 11 | 47 | 8.4 | 85 | — | — | — |
| C-2 | 1769 | 0.834 | 0.54 | 2.32 | 11 | 47 | 12.3 | 86 | — | — | — |
| C-3 | 1759 | 0.828 | 0.55 | 2.24 | 11 | 44 | 7.9 | 84 | — | — | — |
| C-4 | 1752 | 0.823 | 0.54 | 2.20 | 9 | 46 | 10.2 | 85 | — | — | — |
| C-5 | 1736 | 0.807 | 0.58 | 2.06 | 11 | 35 | 8.5 | 85 | — | — | — |
| D-1 | 1749 | 0.796 | 0.62 | 1.85 | 11 | 45 | 11.5 | 74 | — | — | — |
| D-2 | 1706 | 0.787 | 0.61 | 1.91 | 10 | 48 | 18.2 | 90 | — | — | — |
| D-3 | 1747 | 0.800 | 0.61 | 1.86 | 9 | 49 | 11.5 | 87 | — | — | — |
| D-4 | 1713 | 0.788 | 0.62 | 1.94 | 10 | 40 | 12.3 | 80 | — | — | — |
| E-1 | 2390 | 0.782 | 0.47 | 1.56 | 7.3 | 54 | 12.1 | 84 | — | — | — |
| E-2 | 2337 | 0.803 | 0.44 | 1.60 | 6.3 | 62 | 10.3 | 86 | — | — | — |
| E-3 | 2358 | 0.834 | 0.41 | 1.96 | 6.0 | 72 | 11.1 | 86 | — | — | — |
| E-4 | 2351 | 0.823 | 0.42 | 1.85 | 5.6 | 65 | 12.7 | 86 | — | — | — |
| E-5 | 2216 | 0.706 | 0.54 | 1.34 | 40.0 | 5 | 11.3 | 86 | — | — | — |
| E-6 | 2238 | 0.715 | 0.53 | 1.37 | 34.0 | 7 | 8.5 | 86 | — | — | — |
| E-7 | 2245 | 0.728 | 0.52 | 1.42 | 21.0 | 15 | 8.8 | 82 | — | — | — |
| E-8 | 2294 | 0.757 | 0.49 | 1.58 | 11.3 | 23 | 7.1 | 84 | — | — | — |
| E-9 | 2377 | 0.829 | 0.42 | 1.90 | 8.3 | 64 | 12.2 | 86 | — | — | — |
| E-10 | 2341 | 0.817 | 0.43 | 1.87 | 8.0 | 61 | 14.1 | 86 | — | — | — |
| E-11 | 2322 | 0.817 | 0.44 | 1.88 | 7.6 | 60 | 14.4 | 86 | — | — | — |
| E-12 | 2313 | 0.812 | 0.44 | 1.87 | 7.1 | 55 | 10.7 | 85 | — | — | — |
| F-1 | 2365 | 0.875 | 0.36 | 2.45 | 8.0 | 105 | 10.5 | 80 | — | — | — |
| F-2 | 2392 | 0.878 | 0.36 | 2.40 | 7.7 | 90 | 12.0 | 80 | — | — | — |
| F-3 | 2392 | 0.879 | 0.37 | 2.35 | 7.1 | 90 | 13.0 | 80 | — | — | — |
| F-4 | 2402 | 0.877 | 0.36 | 2.49 | 7.2 | 105 | 12.2 | 80 | — | — | — |
| F-5 | 2367 | 0.844 | 0.40 | 2.08 | 12.6 | 60 | 12.4 | 80 | — | — | — |
| F-6 | 2357 | 0.844 | 0.40 | 2.32 | 13.8 | 54 | 11.2 | 78 | — | — | — |
| F-7 | 2361 | 0.825 | 0.41 | 1.99 | 15.1 | 44 | 11.8 | 78 | — | — | — |
| G-1 | 2365 | 0.868 | 0.37 | 2.28 | 9.3 | 81 | 11.3 | 84 | — | — | — |
| G-2 | 2375 | 0.870 | 0.36 | 2.29 | 9.9 | 78 | 12.4 | 86 | — | — | — |
| G-3 | 2381 | 0.872 | 0.35 | 2.36 | 11.1 | 75 | 18.5 | 85 | — | — | — |
| G-4 | 2387 | 0.874 | 0.35 | 2.37 | 12.5 | 72 | 11.8 | 86 | — | — | — |
| G-5 | 2397 | 0.887 | 0.34 | 2.51 | 7.1 | 87 | 10.2 | 82 | — | — | — |
| G-6 | 2378 | 0.874 | 0.36 | 1.65 | 6.2 | 83 | 15.9 | 85 | — | — | — |
| G-7 | 2360 | 0.872 | 0.36 | 2.44 | 6.7 | 79 | 12.5 | 85 | — | — | — |
| H-1 | 2399 | 0.900 | 0.34 | 2.63 | 7.6 | 98 | — | — | 18.6 | — | — |
| H-2 | 2399 | 0.901 | 0.33 | 2.66 | 7.4 | 102 | — | — | 18.1 | — | — |
| H-3 | 2415 | 0.901 | 0.33 | 2.64 | 7.2 | 105 | — | — | 23.0 | — | — |
| H-4 | 2426 | 0.898 | 0.33 | 2.69 | 7.2 | 105 | — | — | 20.9 | — | — |
| H-5 | 2408 | 0.903 | 0.32 | 2.83 | 6.3 | 115 | — | — | 19.9 | — | — |
| H-6 | 2421 | 0.907 | 3.25 | 2.78 | 6.2 | 114 | — | — | 19.5 | — | — |
| H-7 | 2428 | 0.904 | 0.33 | 2.73 | 6.2 | 113 | — | — | 16.9 | — | — |
| H-8 | 2449 | 0.912 | 0.33 | 2.79 | 6.3 | 112 | — | — | 17.5 | — | — |
| I-1 | 1793 | 0.842 | 0.55 | 2.19 | 8.0 | 57 | 11.2 | — | — | — | 129 |
| I-2 | 1848 | 0.862 | 0.51 | 2.56 | 7.5 | 67 | 17.4 | — | — | — | 152 |
| I-3 | — | — | — | — | 4.8 | 94 | 19.0 | — | — | — | 177 |
| I-4 | 1824 | 0.824 | 0.57 | — | — | — | 18.3 | — | — | — | — |
| I-5 | 1834 | 0.846 | 0.54 | — | — | — | 19.4 | — | — | — | — |

TABLE THREE
Loop Test Results

| LOOP TEST | |
|---|---|
| Room Temperature | 40° C./80% RH |

| Sample # | Debris | Friction | Debris | Friction |
|---|---|---|---|---|
| C1 | 3.5 | 4.4 | 2.0 | 3.3 |
| C2 | 2.3 | 2.6 | 1.8 | 2.2 |
| C3 | 3.3 | 4.1 | 1.5 | 2.3 |
| C4 | 2.5 | 3.2 | 1.5 | 2.1 |
| D1 | 5.0 | 3.6 | 4.0 | 3.1 |
| D2 | 4.0 | 3.0 | 3.0 | 2.4 |
| D3 | 2.5 | 3.2 | 2.0 | 2.8 |
| D4 | 3.0 | 2.9 | 1.5 | 2.5 |

Conclusions

A synergistic effect in the pigment orientation ratio, squareness (Sq) and susceptibility was observed as HMPA was incorporated into the formula, when D 3-101 pigment was used. Orientation ratio, squareness and susceptibility values tended to increase with increasing HMPA concentrations up to about 0.5% HMPA, with the values tending to decrease with HMPA concentrations in excess of about 0.5%. Pigment orientation ratio, squareness and susceptibility characterize dispersion quality, which was optimized at 0.5% HMPA.

Squareness was observed to decrease slightly in a nearly linear fashion with increasing HMPA concentrations when HM-101 pigment was used. However, the level of decrease was not statistically significant.

Elastic modulus (E′) tended to increase with increasing HMPA concentrations up to about 0.5% HMPA, with the values tending to decrease slightly with HMPA concentrations in excess of about 0.5%. Elastic modulus characterizes durability, which was optimized at 0.5% HMPA. Hence, the elastic modulus of an information storage layer can be enhanced by treating the pigment particles with a combination of 4-NBA and HMPA without sacrificing the squareness of the tape.

Without intending to be bound by a particular theory, it can be hypothesized that the decrease in elastic modulus (E′) observed with an increased concentration of HMPA above about 0.5 wt % is caused by a reduction in crosslinking density as a result of an increase in the bonding of isocyanate groups on the binder with hydroxy groups on the HMPA at the expense of the bonding of isocyanate groups on the binder with hydroxy groups on the binder itself

A decrease in debris generation and friction values, under both ambient and increased temperature and relative humidity conditions, was observed upon treatment of pigment particles with a combination of HMPA and 4-HMPA as compared to 4-NBA alone.

A combination of approximately 7 parts 4—NBA to 1 part HMPA (i.e., about 3.5 wt % 4-NPA and 0.5 wt % HMPA) was observed to have substantially no effect upon the film magnetic properties of coercivity (Hc) and Switching Field Distribution (SFD), Rodenstock, or Gloss 45°),

I claim:

1. A surface treated magnetic pigment particle suitable for use with a binder in an information recording layer of magnetic recording media, comprising (a) a magnetic pigment particle, (b) a first surface treatment agent adsorbed onto the surface of the magnetic pigment particle having the formula E—X¹—A¹ wherein (i) E is an electron withdrawing group which is not reactive with the binder, (ii) A¹ is an acidic group, and (iii) X¹ is a divalent moiety, and (c) a second surface treatment agent adsorbed onto the surface of the magnetic pigment particle having the formula F—X²—A² wherein (i) F is a functional group reactive with the binder, (ii) A² is an acidic group, and (iii) x² is a divalent C₁₋₄ alkyl moiety.

2. The treated magnetic pigment particle of claim 1 wherein the metal particle is a ferromagnetic metal particle.

3. The treated magnetic pigment particle of claim 1 wherein the treated magnetic pigment particle is the product obtained by treating the metal particles with a surface treatment composition at a wt ratio of metal particles to surface treatment composition of between about 20:1 to about 50:1.

4. The treated magnetic pigment particle of claim 1 wherein the treated magnetic pigment particle is the product obtained by treating the metal particles with a surface treatment composition including a wt ratio of first surface treatment agent to second surface treatment agent of between about 20:1 to about 3:1.

5. The treated magnetic pigment particle of claim 1 wherein the treated magnetic pigment particle is the product obtained by treating the metal particle with (i) a surface treatment composition at a wt ratio of metal particles to surface treatment composition of between about 20:1 to about 35:1, and (ii) a surface treatment composition including a wt ratio of first surface treatment agent to second surface treatment agent of between about 10:1 to about 5:1.

6. The treated magnetic pigment particle of claim 1 wherein E of the first surface treatment agent is —NO₂.

7. The treated magnetic pigment particle of claim 1 wherein A of the first surface treatment agent is —COOH.

8. The treated magnetic pigment particle of claim 1 wherein X of the first surface treatment agent is an aromatic divalent moiety.

9. The treated magnetic pigment particle of claim 1 wherein the first surface treatment agent is 4-nitrobenzoic acid.

10. The treated magnetic pigment particle of claim 1 wherein F of the second surface treatment agent is —OH.

11. The treated magnetic pigment particle of claim 1 wherein A of the second surface treatment agent is —PO(OH)₂.

12. The treated magnetic pigment particle of claim 1 wherein X of the second surface treatment agent is a divalent methyl moiety.

13. The treated magnetic pigment particle of claim 1 wherein the second surface treatment agent is hydroxymethyl phosphonic acid.

14. The treated magnetic pigment particle of claim 13 wherein the treated magnetic pigment particle is the product obtained by treating the metal particles with a surface treatment composition including a wt ratio of first surface treatment agent to second surface treatment agent of between about 8:1 to about 6:1.

15. The treated magnetic pigment particle of claim 9 wherein the second surface treatment agent is hydroxymethyl phosphonic acid.

16. A magnetic recording medium, comprising:
(a) a substrate; and
(b) an information storing layer provided on the substrate including at least:
(1) a binder, and
(2) a plurality of magnetic pigment particles with (a) a first surface treatment agent adsorbed onto the surface of the magnetic pigment particle which is not reactive with the binder, and (b) a second surface treatment agent adsorbed onto the surface of the magnetic pigment particle which is reactive with the binder.

17. The magnetic recording medium of claim 16 wherein (i) the first surface treatment agent has the formula E—X¹—A¹ wherein (i) E is an electron withdrawing group which does not appreciably crosslink with the binder, (ii) A¹ is an acidic group, and (iii) X¹ is a divalent moiety, and (b) the second surface treatment agent has the formula F—X—A² wherein (i) F is a functional group capable of crosslinking with the binder, (ii) A² is an acidic group, and (iii) X² is a divalent C₁₋₄ alkyl moiety.

18. The magnetic recording medium of claim 16 wherein the binder includes isocyanate functional groups.

19. The magnetic recording medium of claim 16 wherein the binder includes a polyurethane polymer.

20. The magnetic recording medium of claim 16 wherein the metal particle is a ferromagnetic metal particle.

21. The magnetic recording medium of claim 16 wherein the treated magnetic pigment particle is the product obtained by treating the metal particles with a surface treatment composition at a wt ratio of metal particles to surface treatment composition of between about 20:1 to about 50:1.

22. The magnetic recording medium of claim 16 wherein the treated magnetic pigment particle is the product obtained by treating the metal particles with a surface treatment composition including a wt ratio of first surface treatment agent to second surface treatment agent of between about 20:1 to about 3:1.

23. The magnetic recording medium of claim 16 wherein the treated magnetic pigment particle is the product obtained by treating the metal particle with (i) a surface treatment composition at a wt ratio of metal particles to surface treatment composition of between about 20:1 to about 35:1, and (ii) a surface treatment composition including a wt ratio of first surface treatment agent to second surface treatment agent of between about 10:1 to about 5:1.

24. The magnetic recording medium of claim 17 wherein E of the first surface treatment agent is —NO₂.

25. The magnetic recording medium of claim 17 wherein A¹ is —COOH.

26. The magnetic recording medium of claim 17 wherein X¹ is an aromatic divalent moiety.

27. The magnetic recording medium of claim 17 wherein the first surface treatment agent is 4-nitrobenzoic acid.

28. The magnetic recording medium of claim 17 wherein F of the second surface treatment agent is —OH.

29. The magnetic recording medium of claim 17 wherein A² is —PO(OH)₂.

30. The magnetic recording medium of claim 17 wherein X² is a divalent methyl moiety.

31. The magnetic recording medium of claim 17 wherein the second surface treatment agent is hydroxymethyl phosphonic acid.

32. The magnetic recording medium of claim 31 wherein the treated magnetic pigment particle is the product obtained by treating the metal particles with a surface treatment composition including a wt ratio of first surface treatment agent to second surface treatment agent of between about 8:1 to about 6:1.

33. The magnetic recording medium of claim 27 wherein the second surface treatment agent is hydroxymethyl phosphonic acid.
